(19) United States
(12) Patent Application Publication
(10) Pub. No.: US 2026/0267728 A1
(43) Pub. Date: Sep. 10, 2026

(54) INFORMATION PROCESSING SYSTEM, IMFORMATION PROCESSING METHOD, AND NON-TRANSITORY COMPUTER READABLE MEDIUM

(71) Applicant: FUJIFILM Business Innovation Corp., Tokyo (JP)

(72) Inventors: Nobukazu MIYOSHI, Kanagawa (JP); Shunji Tsunashima, Kanagawa (JP); Ibuki Kuroda, Kanagawa (JP)

(73) Assignee: FUJIFILM Business Innovation Corp., Tokyo (JP)

(21) Appl. No.: 19/332,960

(22) Filed: Sep. 18, 2025

(30) Foreign Application Priority Data
Mar. 10, 2025 (JP) 2025-037752

(51) Int. Cl. G06F 11/07

(52) U.S. Cl. CPC G06F 11/079; G06F 11/0733

(57) ABSTRACT

An information processing system includes a functional module; a module control processor configured to control the functional module; a monitor that monitors a state of register access from the module control processor to the functional module and detects an anomaly in the module control processor; and a principal processor configured to, when an anomaly in the module control processor is detected by the monitor, perform recovery processing for the information processing system, wherein the monitor compares expected value data in which at least part of access order, protocol, address, and data content for register access from the module control processor to the functional module is omitted with access order, protocol, access address, and data content in register access from the module control processor to the functional module, and in a case where results of the comparison do not match, detects occurrence of an anomaly in the module control processor.

### CROSS-REFERENCE TO RELATED APPLICATIONS

This application is based on and claims priority under 35 USC 119 from Japanese Patent Application No. 2025-037752 filed Mar. 10, 2025.

### BACKGROUND

### (i) Technical Field

The present disclosure relates to an information processing system, an information processing method, and a non-transitory computer readable medium.

### (ii) Related Art

In Japanese Unexamined Patent Application Publication No. 2006-133969, an information processing apparatus capable of finding out a setting error in start order in an early stage of software development is described.

In Japanese Unexamined Patent Application Publication No. 2012-048277, a semiconductor integrated circuit capable of performing efficient debugging in a functional module that operates based on information set by register access in a preset control procedure, such as image processing, is described.

In Japanese Unexamined Patent Application Publication No. 2010-211391, a central processing unit (CPU) monitoring apparatus that detects temporary disturbance in a series of operations as a monitoring target when a CPU accesses a memory or a register in a normal area or when the CPU performs program processing, is described.

### SUMMARY

An information processing system including a functional module, a module control processor for controlling the functional module, and a monitor that monitors the state of register access from the module control processor to the functional module and detects an anomaly in the module control processor is suggested. In the information processing system, when an anomaly in the module control processor is detected by the monitor, system recovery is performed.

The monitor sequentially compares expected value data of access order, protocol, address, and data content for register access from the module control processor to the functional module with access order, protocol, access address, and data content in register access from the module control processor to the functional module. In the case where results of the comparison do not match, the monitor detects occurrence of an anomaly in the module control processor.

In this case, however, expected value data of all the register accesses from the module control processor to the functional module needs to be stored in advance in an external memory, which requires an increase in the memory size.

Aspects of non-limiting embodiments of the present disclosure relate to providing an information processing system, an information processing method, and a non-transitory computer readable medium capable of reducing the size of a memory that stores expected value data, compared to a case where anomaly detection is performed by comparison using all the data regarding register access.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a functional module; a module control processor configured to control the functional module; a monitor that monitors a state of register access from the module control processor to the functional module and detects an anomaly in the module control processor; and a principal processor configured to, when an anomaly in the module control processor is detected by the monitor, perform recovery processing for the information processing system. The monitor compares expected value data in which at least part of access order, protocol, address, and data content for register access from the module control processor to the functional module is omitted with access order, protocol, access address, and data content in register access from the module control processor to the functional module, and in a case where results of the comparison do not match, detects occurrence of an anomaly in the module control processor.

### BRIEF DESCRIPTION OF THE DRAWINGS

Exemplary embodiments of the present disclosure will be described in detail based on the following figures, wherein:

FIG. 1 is an external view of an image forming apparatus according to an exemplary embodiment;

FIG. 2 is a block diagram illustrating a hardware configuration of the image forming apparatus;

FIG. 3 is a block diagram illustrating a functional configuration of the image forming apparatus;

FIG. 4 is a diagram illustrating an example of types of register accesses and address ranges for a functional module;

FIG. 5 is a diagram illustrating an example of expected value data;

FIG. 6 is a diagram illustrating an example of expected value data; and

FIG. 7 is a diagram illustrating another configuration example of the functional module.

### DETAILED DESCRIPTION

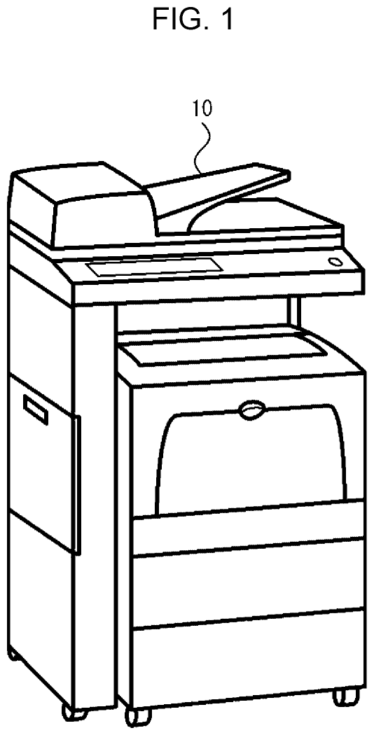

Hereinafter, exemplary embodiments of the present disclosure will be described in detail with reference to drawings. FIG. 1 is an external view of an image forming apparatus 10 according to an exemplary embodiment.

As illustrated in FIG. 1, the image forming apparatus 10 is a so-called multifunction machine provided with multiple functions including a copy function, a print function, a facsimile function, a scan function, and the like. The image forming apparatus 10 is an example of an information processing system according to an exemplary embodiment of the present disclosure.

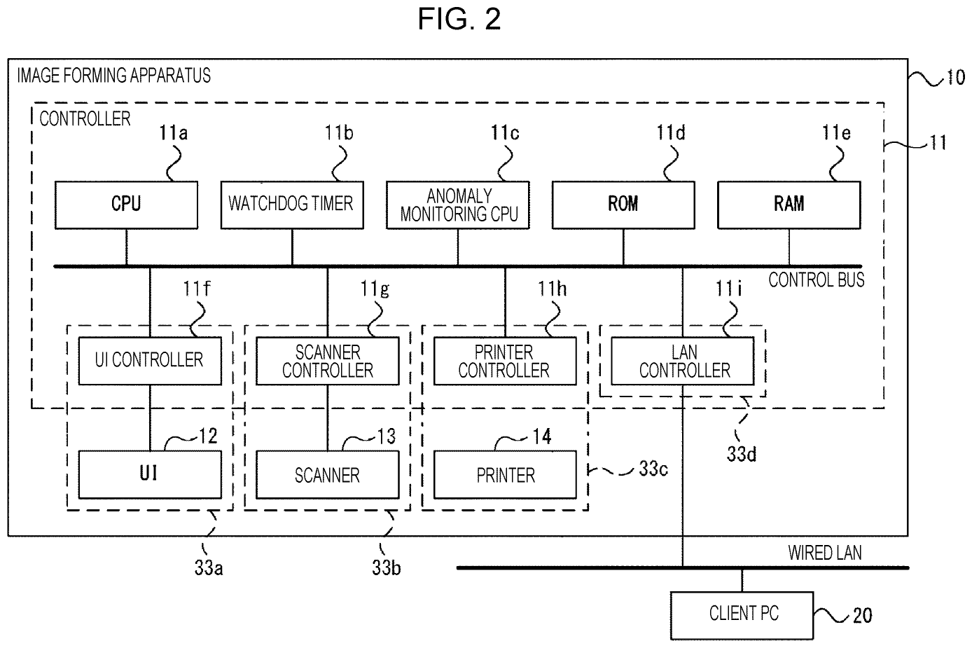

Next, a hardware configuration of the image forming apparatus 10 according to this exemplary embodiment will be described. FIG. 2 is a block diagram illustrating a hardware configuration of the image forming apparatus 10.

As illustrated in FIG. 2, the image forming apparatus 10 includes a controller 11, a user interface (UI) 12, a scanner 13, and a printer 14. These component elements are connected by a control bus.

The UI 12 includes a touch panel, a physical button, and the like and receives an instruction from a user. The scanner 13 reads a document loaded onto the image forming apparatus 10 as image data. The printer 14 performs processes including charging, exposure, developing, transfer, fixing, and the like to print an image on a recording medium such as printing paper.

The controller 11 controls the entire image forming apparatus 10. The controller 11 includes a CPU 11a, a watchdog timer 11b, an anomaly monitoring CPU 11c, a read only memory (ROM) 11d, a random access memory (RAM) 11e, a UI controller 11f, a scanner controller 11g, a printer controller 11h, and a local area network (LAN) controller 11i.

The CPU 11a performs predetermined processing based on a program read from the ROM 11d and loaded onto the RAM 11e.

As described above, in this exemplary embodiment, the CPU 11a reads and executes a program stored in the ROM 11d. However, the CPU 11a does not necessarily read and execute the program stored in the ROM 11d. The program may be recorded in a computer-readable recording medium and supplied. For example, the program may be recorded in an optical disc such as a compact disc-read only memory (CD-ROM) or a digital versatile disc-read only memory (DVD-ROM) or in a semiconductor memory such as a universal serial bus (USB) memory or a memory card and supplied. Furthermore, the program may be acquired from an external apparatus through the LAN controller 11i.

The watchdog timer 11b monitors the operating state of the CPU 11a. The anomaly monitoring CPU 11c monitors the state of register access from the CPU 11a to each functional module and detects occurrence of an anomaly in the CPU 11a. The anomaly monitoring CPU 11c is an example of a monitor in an exemplary embodiment of the present disclosure.

The UI controller 11f controls the UI 12. The scanner controller 11g controls the scanner 13. The printer controller 11h controls the printer 14. The LAN controller 11i communicates with an external apparatus such as a client personal computer (PC) 20 via a LAN.

The UI controller 11f and the UI 12 form a UI module 33a. The scanner controller 11g and the scanner 13 form a scanner module 33b. The printer controller 11h and the printer 14 form a printer module 33c. The LAN controller 11i forms a LAN module 33d. Each of the UI module 33a, the scanner module 33b, the printer module 33c, and the LAN module 33d is an example of a functional module in an exemplary embodiment of the present disclosure.

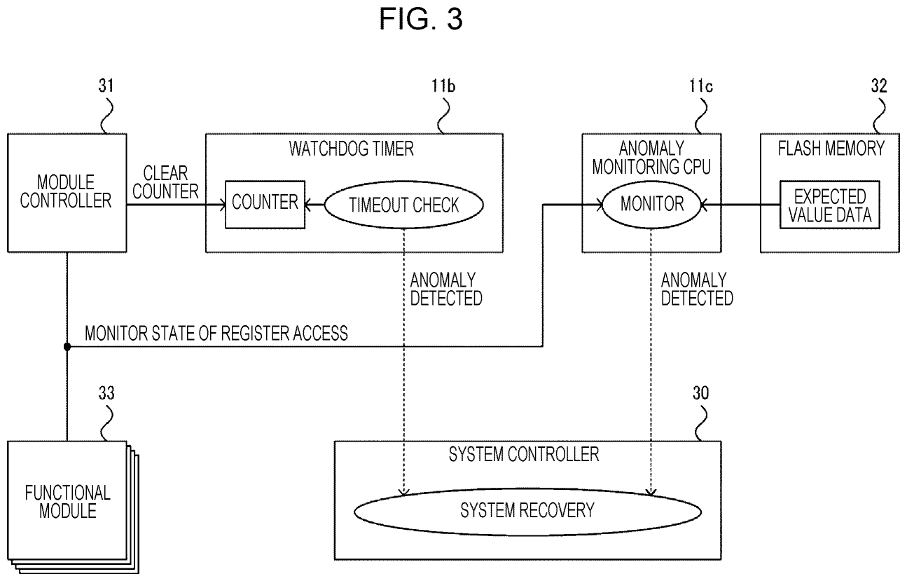

Next, a functional configuration of a principal section of the image forming apparatus 10 according to this exemplary embodiment will be described. FIG. 3 is a block diagram illustrating a functional configuration of a principal section of the image forming apparatus 10.

As illustrated in FIG. 3, the image forming apparatus 10 includes a system controller 30, a module controller 31, a flash memory 32, functional modules 33, the watchdog timer 11b, and the anomaly monitoring CPU 11c.

The system controller 30 controls the entire image forming apparatus 10. The module controller 31 controls each of the functional modules 33. The CPU 11a includes the system controller 30 and the module controller 31.

That is, the CPU 11a is an example of a module control processor and a principal processor in an exemplary embodiment of the present disclosure. In this exemplary embodiment, the single CPU 11a includes the module control processor and the principal processor. However, the module control processor and the principal processor may form different CPUs.

The flash memory 32 stores expected value data, which will be described later. The functional modules 33 include the UI module 33a, the scanner module 33b, the printer module 33c, and the LAN module 33d mentioned above.

In the image forming apparatus 10 according to this exemplary embodiment, the anomaly monitoring CPU 11c monitors the state of register access from the module controller 31 to a functional module 33. When the anomaly monitoring CPU 11c detects occurrence of an anomaly in the module controller 31, the system controller 30 performs recovery processing (so-called system recovery).

The anomaly monitoring CPU 11c compares expected value data with access order, protocol, access address, and data content in register access from the module controller 31 to the functional module 33. In the case where results of the comparison do not match, the anomaly monitoring CPU 11c detects occurrence of an anomaly in the module controller 31.

Anomaly detection by the anomaly monitoring CPU 11c may be performed for all the functional modules 33 included in the image forming apparatus 10 or anomaly detection may be performed for part of the functional modules 33. In the case where anomaly detection is performed for part of the functional modules 33, it is desirable that anomaly detection may be performed for, for example, the printer module 33c, which is affected by an anomaly more than other functional modules 33 are, by the anomaly monitoring CPU 11c.

The expected value data represents data in which at least part of access order, protocol (read (r) or write (w)), address, and data content for register access from the functional module 33 to the functional module 33 is omitted.

It is desirable that the expected value data include information about at least access order and address. Furthermore, it is desirable that the expected value data include information about at least one or more of protocol, access width, and the number of times of access to the same address.

Processing by the anomaly monitoring CPU 11c for monitoring the state of register access from the module controller 31 to the functional module 33 will be described in detail below.

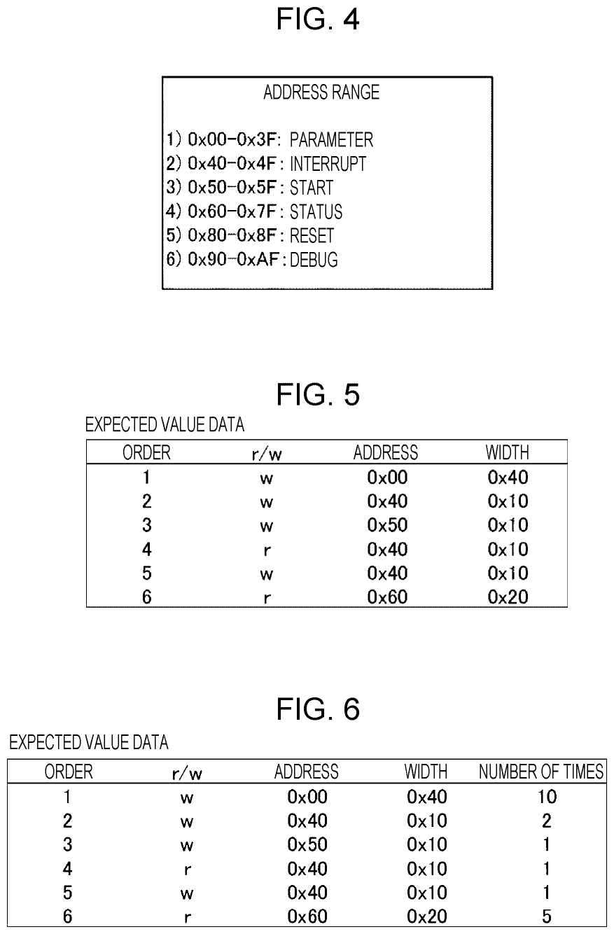

For example, as illustrated in FIG. 4, types of register accesses and address ranges are set for each functional module 33.

If the anomaly monitoring CPU 11c compares all the contents in all the register accesses from the module controller 31 to the functional module 33 with expected value data, the amount of the expected value data is as described below.

For example, the data size of the expected value data used for comparison for a single register access is 9 bytes, where protocol takes 1 byte, address takes 4 bytes, and data takes 4 bytes.

Furthermore, in the case where “parameter write” is performed ten times, “interrupt write” is performed twice, “start write” is performed once, “interrupt read” is performed once, “interrupt write” is performed once, and “status read” is performed five times in a single functional process, data comparison is required to be performed twenty times in total for the single functional process.

Therefore, expected value data for the single functional process has 180 bytes.

In contrast, in the image forming apparatus 10 according to this exemplary embodiment, expected value data represents data in which at least part of access order, protocol, address, the number of times of consecutive access to the same address, and data content for register access from the module controller 31 to the functional module 33 is omitted.

For example, as illustrated in FIG. 5, in the case where expected value data includes only access order, protocol, address, and access width without the contents of the functional process mentioned above not being changed, the amount of the expected value data is as described below.

Data content is omitted in the expected value data used for comparison for a single register access. Therefore, the data size of the expected value data used for comparison for the single register access is 7 bytes, where protocol takes 1 byte, address takes 4 byte, and data width takes 2 bytes, as described above.

Furthermore, since the number of times of consecutive access to the same address is omitted in the expected value data, data comparison is required to be performed six times in total: “parameter write,” “interrupt write,” “start write,” “interrupt read,” “interrupt write,” and “status read,” for the single functional process.

Therefore, the size of the expected value data for the single functional process is 42 bytes, and the data size of the expected value data is smaller than that in the case where all the contents in all the register accesses from the module controller 31 to the functional module 33 are compared with expected value data.

As illustrated in FIG. 6, information about the number of times of access may be added to the expected value data illustrated in FIG. 5. The data size of the expected value data used for comparison for one type of register access is 9 bytes, where the number of times of access takes 2 bytes. Furthermore, data comparison is required to be performed six times for a single functional process. Therefore, the expected value data for the single functional process has 54 bytes.

Also in this case, the data size of the expected value data is smaller than that in the case where all the contents in all the register accesses from the module controller 31 to the functional module 33 are compared with expected value data.

Furthermore, the image forming apparatus 10 according to this exemplary embodiment includes the watchdog timer 11b. In the case where an instruction to reset the counter is not received from the module controller 31 in a preset reset period and the value of the counter exceeds a threshold value, the watchdog timer 11b detects occurrence of an anomaly in the module controller 31. Also in the case where an anomaly in the module controller 31 is detected by the watchdog timer 11b, the system controller 30 performs recovery processing.

In this case, it is desirable that the reset period of the watchdog timer 11b be set longer than a time required for anomaly detection by the anomaly monitoring CPU 11c.

### Modifications

An image forming apparatus as an information processing system according to an exemplary embodiment of the present disclosure has been described above. However, the present disclosure is not limited to the exemplary embodiment described above and changes may be made in an appropriate manner.

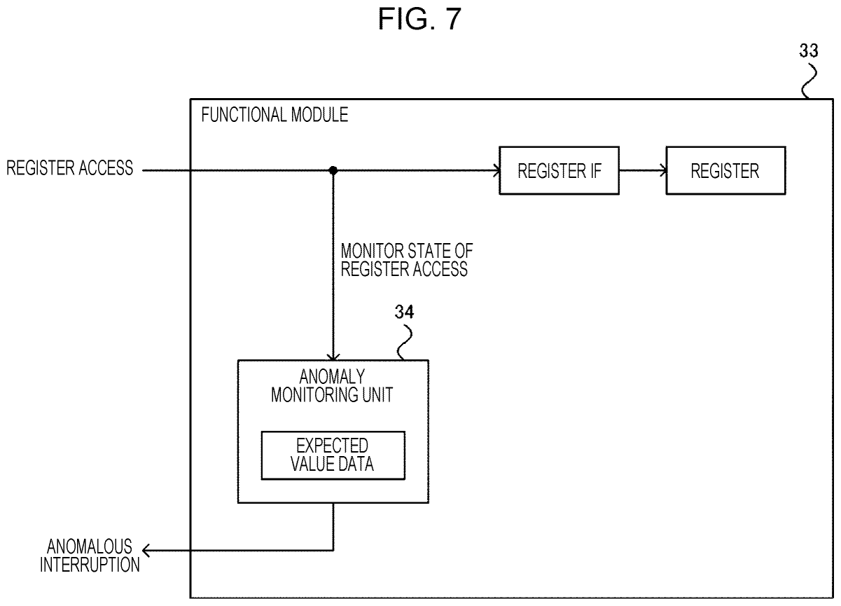

For example, the monitor does not necessarily include the anomaly monitoring CPU 11c. As illustrated in FIG. 7, an anomaly monitoring unit 34 may be provided inside the functional modules 33 by circuit implementation.

Furthermore, in the case where a plurality of functional processes are performed in the functional module 33, expected value data may be stored for each of the functional processes.

Furthermore, the present disclosure is not limited to an image forming apparatus. The present disclosure may be applicable to any type of system as long as the system is an information processing system including a functional module that performs information processing in cooperation with a processor.

Furthermore, in the present disclosure, the term “system” includes a system including a plurality of apparatuses and a system including a single apparatus.

Furthermore, the present disclosure is also applicable to a program and a program product.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
a functional module;
a module control processor configured to control the functional module;
a monitor that monitors a state of register access from the module control processor to the functional module and detects an anomaly in the module control processor; and
a principal processor configured to, when an anomaly in the module control processor is detected by the monitor, perform recovery processing for the information processing system,
wherein the monitor compares expected value data in which at least part of access order, protocol, address, and data content for register access from the module control processor to the functional module is omitted with access order, protocol, access address, and data content in register access from the module control processor to the functional module, and in a case where results of the comparison do not match, detects occurrence of an anomaly in the module control processor.
(((2)))

The information processing system according to (((1))), wherein the expected value data includes information about at least access order and address.
(((3)))

The information processing system according to (((2))), wherein the expected value data further includes information about at least one or more of protocol, access width, and the number of times of access to the same address.
(((4)))

The information processing system according to any one of (((1))) to (((3))), further comprising:
a watchdog timer that monitors an operating state of the module control processor.
(((5)))

The information processing system according to (((4))), wherein a reset period of the watchdog timer is set longer than a time required for anomaly detection by the monitor.
(((6)))

A program causing a monitor in an information processing system to operate, the information processing system including:
a functional module;
a module control processor configured to control the functional module;
the monitor that monitors a state of register access from the module control processor to the functional module and detects an anomaly in the module control processor; and
a principal processor configured to, when an anomaly in the module control processor is detected by the monitor, perform recovery processing for the information processing system,
the program causing the monitor to execute a process comprising:
comparing expected value data in which at least part of access order, protocol, address, and data content for register access from the module control processor to the functional module is omitted with access order, protocol, access address, and data content in register access from the module control processor to the functional module; and
in a case where results of the comparison do not match, detecting occurrence of an anomaly in the module control processor.

What is claimed is:

1. An information processing system comprising:
a functional module;
a module control processor configured to control the functional module;
a monitor that monitors a state of register access from the module control processor to the functional module and detects an anomaly in the module control processor; and
a principal processor configured to, when an anomaly in the module control processor is detected by the monitor, perform recovery processing for the information processing system,
wherein the monitor compares expected value data in which at least part of access order, protocol, address, and data content for register access from the module control processor to the functional module is omitted with access order, protocol, access address, and data content in register access from the module control processor to the functional module, and in a case where results of the comparison do not match, detects occurrence of an anomaly in the module control processor.

2. The information processing system according to claim 1, wherein the expected value data includes information about at least access order and address.

3. The information processing system according to claim 2, wherein the expected value data further includes information about at least one or more of protocol, access width, and the number of times of access to the same address.

4. The information processing system according to claim 1, further comprising:
a watchdog timer that monitors an operating state of the module control processor.

5. The information processing system according to claim 4, wherein a reset period of the watchdog timer is set longer than a time required for anomaly detection by the monitor.

6. An information processing method for causing a monitor in an information processing system to operate, the information processing system including:
a functional module;
a module control processor configured to control the functional module;
the monitor that monitors a state of register access from the module control processor to the functional module and detects an anomaly in the module control processor; and
a principal processor configured to, when an anomaly in the module control processor is detected by the monitor, perform recovery processing for the information processing system,
the method comprising:
comparing expected value data in which at least part of access order, protocol, address, and data content for register access from the module control processor to the functional module is omitted with access order, protocol, access address, and data content in register access from the module control processor to the functional module; and
in a case where results of the comparison do not match, detecting occurrence of an anomaly in the module control processor.

7. A non-transitory computer readable medium storing a program causing a monitor in an information processing system to operate, the information processing system including:
a functional module;
a module control processor configured to control the functional module;
the monitor that monitors a state of register access from the module control processor to the functional module and detects an anomaly in the module control processor; and
a principal processor configured to, when an anomaly in the module control processor is detected by the monitor, perform recovery processing for the information processing system,
the program causing the monitor to execute a process comprising:
comparing expected value data in which at least part of access order, protocol, address, and data content for register access from the module control processor to the functional module is omitted with access order, protocol, access address, and data content in register access from the module control processor to the functional module; and
in a case where results of the comparison do not match, detecting occurrence of an anomaly in the module control processor.
